(19) United States
(12) Patent Application Publication
(10) Pub. No.: US 2026/0312629 A1
(43) Pub. Date: Oct. 8, 2026

(54) BEAMFORMING METHOD AND DEVICE IN RIS ELEMENT GROUPING

(71) Applicant: KNU-INDUSTRY COOPERATION FOUNDATION, Chuncheon-Si (KR)

(72) Inventors: Seung Joon Lee, Seoul (KR); Gil Su Jeong, Samcheoki-Si (KR)

(73) Assignee: KNU-INDUSTRY COOPERATION FOUNDATION, Chuncheon-Si (KR)

(21) Appl. No.: 18/877,582

(22) PCT Filed: Jan. 2, 2024
(86) PCT No.: PCT/KR2024/000001

§ 371 Date: Dec. 20, 2024

(30) Foreign Application Priority Data
Nov. 10, 2023 (KR) 10-2023-0155465

(51) Int. Cl. H04B 7/04; H01Q 3/30; H04B 7/06

(52) U.S. Cl. CPC H04B 7/04013; H01Q 3/30; H04B 7/0617

(57) ABSTRACT

The present invention relates to a beamforming method and device in RIS element grouping. In a beamforming method performed by a wireless device including at least one RIS (Reconfigurable Intelligent Surface) group, the method comprises acquiring a channel estimation value; and determining reflection coefficients for the RIS groups based on the channel estimation value, wherein a reflection coefficient for one of the RIS groups is different from a reflection coefficient for another of the RIS groups.

### TECHNICAL FIELD

The present invention relates to a beamforming method by a wireless device including RIS (Reconfigurable Intelligent Surface) elements.

### BACKGROUND ART

Reconfigurable Intelligent Surface (RIS) is a technology that enhances the propagation range of radio waves by attaching transparent glass or panel-type wave reflectors to locations such as building hallways or glass windows where radio waves have difficulty passing through.

Such RIS typically has a structure where numerous RIS elements are distributed on a general planar surface. Each RIS element functions to reflect incoming signals by altering their phase. However, when channel estimation is performed separately for each RIS element and the phase variation value is controlled, the complexity increases significantly.

To overcome this, it has been previously proposed to group a certain number of RIS elements to perform channel estimation and phase variation value control per group to reduce the complexity and computational load.

In addition, conventional RIS element grouping methods require all RIS elements in the same group to have the same phase variation value. However, this has the disadvantage that all RIS elements in a group have the same phase variation value, resulting in very small beam gains for certain channel directions.

Accordingly, the present invention proposes a beamforming method and device in RIS element grouping that allows phase variation values to be set differently for the RIS elements within the same group.

### DETAILED DESCRIPTION OF THE INVENTION

### Technical Problem

It is one object of the present invention to provide a beamforming method in RIS element grouping in which the phase variation values of RIS elements within the same group can be set differently.

Another object of the present invention is to provide a beamforming method for setting different patterns of phase variation values for different RIS groups.

Another object of the present invention is to provide a beamforming method to address the drawback of reduced beam gain in a specific channel direction when the RIS elements within an RIS group have the same phase variation value.

### Solution to Problem

The present invention relates to a beamforming method in Reconfigurable Intelligent Surface (RIS) element grouping, and in particular, to a beamforming method performed by a wireless device including at least one RIS group, the method comprising: acquiring a channel estimation value; and determining reflection coefficients for the RIS groups based on the channel estimation value; wherein a reflection coefficient for one of the RIS groups is different from a reflection coefficient for another of the RIS groups.

According to an example, each of the RIS groups may include one or more RIS elements. A reflection coefficient of the RIS group may be calculated differently based on phase variation values of the one or more RIS elements.

According to an example, the phase variation values may be set differently for each of the one or more RIS elements included in an identical RIS group.

According to an example, the RIS groups may include a first RIS group and a second RIS group. Phase variation value patterns of RIS elements included in the first RIS group and phase variation value patterns of RIS elements included in the second RIS group may be set to be different from each other. The phase variation value patterns may be configured to maximize a minimum value of a signal beam gain according to a channel direction angle as much as possible.

According to an example, the phase variation values may be determined based on an order of a plurality of RIS groups. Among the phase variation values, phase variation values for the second RIS group may be greater than phase variation values for the first RIS group.

According to an example, an increase rate of the phase variation value, increasing based on the order of the plurality of RIS groups, may be set differently for each of the RIS groups.

According to an example, the phase variation values, increasing based on the order of the plurality of RIS groups, may increase in a quadratic manner.

According to an example, the phase variation values are derived through an iterative optimization algorithm.

In another aspect, a beamforming device performed by a wireless device including at least one of Reconfigurable Intelligent Surface (RIS) groups, the beamforming device comprising: one or more transceivers including the RIS groups; one or more processors configured to control the one or more transceivers; and one or more memories connected to the one or more processors and storing instructions which, when executed by the one or more processors, cause the processors to perform operations. The operations comprise: acquiring a channel estimation value; and determining reflection coefficients for the RIS groups based on the channel estimation value; wherein a reflection coefficient for one of the RIS groups is different from a reflection coefficient for another of the RIS groups.

According to an example, each of the RIS groups may comprise one or more RIS elements. Reflection coefficients for the RIS groups may be calculated differently based on phase variation values of the one or more RIS elements.

### Effects of the Invention

As described above, the present invention provides a beamforming method and device in RIS element grouping, which allows the phase variation values of RIS elements to be controlled differently to design different reflection coefficients for the RIS elements within the same group. Accordingly, the present invention allows the phase variation values of RIS elements in the same group to be set differently, thereby solving the issue of reduced beam gain in a specific channel direction.

Meanwhile, a beamforming method and device in RIS element grouping according to the present invention allow the linear increase rate of RIS elements to be set differently for each RIS group, thereby ensuring a design in which the central directional angles of the beams for the groups are evenly distributed.

Furthermore, the present invention allows the phase variation values of RIS elements within the same group to increase in a quadratic manner, thereby adjusting not only the central direction of the beam but also the beam's width (thickness).

Moreover, the present invention can significantly improve the worst-case performance by maximizing the minimum value of the beam gain according to channel directional angles.

### BRIEF DESCRIPTION OF DRAWINGS

FIG. 1 is a conceptual diagram illustrating a beamforming device in RIS element grouping according to the present invention.

FIG. 2 is a flowchart illustrating a beamforming method in RIS element grouping according to the present invention.

FIG. 3 is a conceptual diagram illustrating a beamforming method and device in RIS element grouping according to the present invention.

FIGS. 4 to 6 are graphs for comparing the performance of the beamforming method and device in RIS element grouping according to the present invention.

### BEST MODE FOR IMPLEMENTATION OF THE INVENTION

Hereinafter, embodiments disclosed in this specification will be described in detail with reference to the accompanying drawings, wherein the same or similar components are assigned the same reference numerals, and redundant descriptions thereof will be omitted. In the following description, the suffixes “module” and “unit” used for components are assigned or interchanged solely for the convenience of drafting this specification and do not, by themselves, have distinct meanings or roles. Furthermore, in describing the embodiments disclosed in this specification, detailed descriptions of related known technologies will be omitted if it is determined that they may obscure the essence of the embodiments disclosed herein. Additionally, the accompanying drawings are provided merely to facilitate understanding of the embodiments disclosed in this specification and should not be construed as limiting the technical scope disclosed herein. It should be understood that all modifications, equivalents, and substitutes within the scope and spirit of the present invention are included.

The present invention relates to a beamforming method and apparatus in RIS element grouping, and the invention will be described in more detail below with reference to the accompanying drawings.

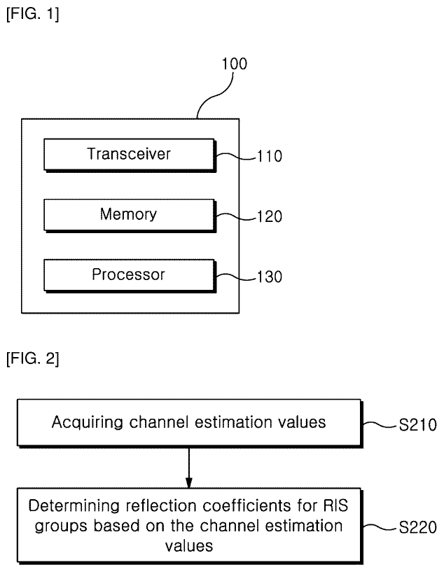

FIG. 1 is a conceptual diagram illustrating a beamforming device in RIS element grouping according to the present invention.

First, the concept of a beamforming method and device in RIS element grouping according to the present invention will be explained with reference to FIG. 1.

Reconfigurable Intelligent Surface (RIS) is a technology that enhances the propagation range of radio waves by attaching transparent glass or panel-type wave reflectors to locations such as building hallways or glass windows where radio waves have difficulty passing through. Such an RIS has a structure in which numerous RIS elements are spread out on a common plane. Each RIS element functions to reflect incident signals by altering their phase. However, when channel estimation is performed separately for each RIS element and the phase variation values are controlled individually, the complexity increases significantly. To overcome this, a previously proposed method involves grouping a certain number of RIS elements and performing channel estimation and phase variation control on a group-by-group basis, thereby reducing complexity and computational load.

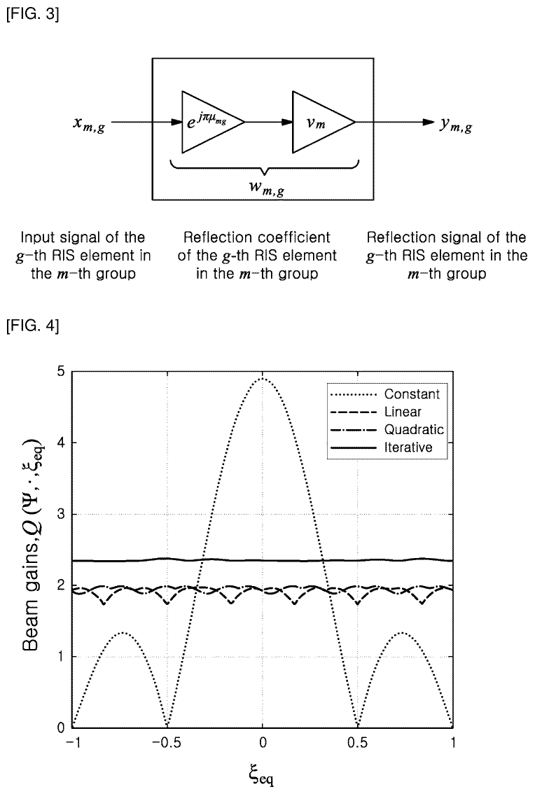

In the conventional RIS element grouping methods, all RIS elements within the same group are configured to have identical phase variation values. However, when all RIS elements within the same group have identical phase variation values, the beam gain in a specific channel direction becomes very small. The ‘Constant’ shown in FIG. 4 represents the performance of the conventional method where the phase variation values of all RIS elements within a group are identical. The assumptions for obtaining the performance graph labeled ‘Constant’ in FIG. 4 are as follows. The assumption for obtaining the graph shown in FIG. 4 is as follows: A total of 24 RIS elements are arranged in a linear form with an interval of half the wavelength. The RIS elements are grouped into sets of four. The four RIS elements within the same group have identical phase variation values. The horizontal axis (ξ_{eq}) represents a value obtained by applying the cosine function to the directional angle of a channel (0° to) 180°. The vertical axis represents a beam gain. Referring to ‘Constant’ shown in FIG. 3, it can be observed that the beam gain becomes zero when ξ_{eq}=±1, and ξ_{eq}=±0.5. This characteristic presents a problem in that it degrades the worst-case performance, which is often an important consideration in communication services.

Therefore, to overcome the problem caused by setting identical phase variation values for all RIS elements within the same group, a beamforming method and device in RIS element grouping according to the present invention are proposed.

Referring to FIG. 1, a beamforming device in RIS element grouping according to the present invention (100, hereinafter referred to as ‘the device’) may be configured to include at least one of a transceiver (110), a memory (120), and a processor (130). At this time, the device according to the present invention (100) is not limited to the aforementioned components and may further include components that perform the same or similar functions as described in this specification.

First, the transceiver (110) may be connected to the processor (130) and may transmit and/or receive wireless signals through one or more antennas. The transceiver (110) may include a transmitter and/or a receiver. The transceiver (110) may include at least one RIS, wherein the RIS may be configured as a group of one or more RIS elements.

Meanwhile, the memory (120) may store various types of data, signals, messages, information, programs, codes, instructions, or commands. The memory (120) may be configured as a ROM (read-only memory), RAM (random access memory), flash memory, hard drive, register, cache memory, computer-readable storage medium, or a combination thereof. The memory (120) may be located either inside or outside the processor (130). Additionally, the memory (120) may be connected to the processor (130) through various technologies, such as wired or wireless connections.

Meanwhile, the processor (130) may be implemented using hardware, firmware, software, or a combination thereof. The descriptions, functions, procedures, proposals, methods, and/or operation flowcharts disclosed in this specification may be implemented using firmware or software, and the firmware or software may be configured to include modules, procedures, functions, and so on. The firmware or software configured to perform the descriptions, functions, procedures, proposals, methods, and/or operation flowcharts disclosed in this specification may be included in one or more processors (130) or stored in one or more memories (120) and driven by one or more processors (130). The descriptions, functions, procedures, proposals, methods, and/or operation flowcharts disclosed in this specification may be implemented using firmware or software in the form of codes, commands, and/or a set of commands.

Furthermore, the processor (130) may control the overall operation of the device according to the present invention (100).

### Mode for Implementation of the Invention

FIG. 2 is a flowchart illustrating a beamforming method in RIS element grouping according to the present invention. FIG. 3 is a conceptual diagram illustrating a beamforming method and device in RIS element grouping according to the present invention. FIGS. 4 to 6 are graphs for comparing the performance of the beamforming method and device in RIS element grouping according to the present invention.

Hereinafter, a beamforming method in RIS element grouping according to the present invention will be described with reference to the configuration of the aforementioned device (see FIG. 2).

The present invention relates to a beamforming method in RIS element grouping, and in the method performed by a wireless device including at least one RIS group, the processor (130) may first acquire channel estimation values for calculating the reflection coefficient values of the RIS elements (S210). Here, the channel estimation values are variable values that may change depending on the instantaneous channel state.

Meanwhile, the processor (130) may determine reflection coefficients for the RIS groups based on the channel estimation values (S220). The processor (130) may determine the reflection coefficients based on the phase variation values of the RIS elements in the RIS groups and the channel estimation values. Here, the reflection coefficients may be set differently for each RIS group. For example, the reflection coefficient of any one of the RIS groups may differ from that of another within the same set of RIS groups.

Meanwhile, each RIS group includes one or more RIS elements, and the reflection coefficients of the RIS groups may be calculated differently depending on the phase variation values of the one or more RIS elements.

For example, assume that the RIS is composed of N RIS elements. Further, assume that these N RIS elements are divided into M groups, and each group consists of G RIS elements. Referring to FIG. 3, the reflection coefficient of the g-th RIS element within the m-th group,

$${ω}_{m g} = {e}^{j π {μ}_{m g}} \cdot {v}_{m} ,$$

along with an incident signal (x_{mg}) and a reflected signal (t_{mg}) of this RIS element, are shown. The reflection coefficient is composed of the product of e^{jπ}^{_{μmg}} and υₘ. υₘ is set according to the instantaneous state of the varying channel. {μ_{mg}|1≤m≤M, 1≤g≤G} may be designed to maximize the minimum beam gain according to the channel direction as much as possible.

Meanwhile, the processor (130) may individually control the phase variation values of the RIS elements within the same group, making them different for each RIS element. Furthermore, the processor (130) may control the phase variation value patterns differently for each RIS group.

For example, at least one RIS group may be composed of four RIS elements. If the reflection coefficient values of the four RIS elements in a specific group are [ω1 ω2 ω3 ω4], then in the conventional RIS element grouping, the reflection coefficient values of the RIS elements may be as determined [ω1 ω2 ω3 ω4]=υ·[1 1 1 1]. Here, υ is a value that is selected differently depending on the state of the channel. Therefore, channel estimation is required to determine an appropriate υ value. While [ω1 ω2 ω3 ω4] may vary according to the channel state, the four values constituting this can be set to be identical. Although the υ values of RIS elements in different groups may be controlled differently, the reflection coefficient values within each group are set uniformly.

Meanwhile, in the beamforming method in RIS element grouping according to the present invention, the processor (130) may set the reflection coefficient values of the RIS elements as [ω1 ω2 ω3 ω4]=υ·[e^{jπμ1} e^{jπμ2} e^{jπμ3} e^{jπμ4}]. Here, υ is a value that can vary according to the instantaneous state of the channel, whereas [μ1 μ2 μ3 μ4] is a value that is set to remain constant regardless of the channel state. Additionally, the processor may control the pattern of [μ1 μ2 μ3 μ4] to be set differently for each group. Therefore, even if the four component values are different, [μ1 μ2 μ3 μ4] has a very small beam gain at a specific channel direction angle. However, the channel direction angle at which the beam gain becomes very small may vary depending on the pattern of. Accordingly, the processor according to the present invention can configure [μ1 μ2 μ3 μ4] differently for each group, thereby preventing all groups from simultaneously having a small beam gain at any arbitrary channel direction angle.

Meanwhile, in a beamforming method in RIS element grouping according to the present invention, there are various methods for configuring the phase variation value [μ1 μ2 μ3 μ4] patterns used to set the reflection coefficient values of the RIS groups.

The first method is that the processor (130), according to the present invention, may set phase variation values of RIS elements in at least one RIS group to increase linearly. For example, the processor 130 may control the phase variation value to increase linearly by determining the phase variation value based on the order of the plurality of RIS groups and setting the phase variation value for a second RIS group to be greater than the phase variation value for a first RIS group among the phase variation values. At this time, the processor (130) may set the linear increase rate differently for each RIS group in order to set the configuration of [μ1 μ2 μ3 μ4] differently for each RIS group. Here, the increase rate can determine the central directional angle of the beam. As an example, the processor (130) may control the increase rate of the linearly increasing phase variation values to be different for each RIS group based on the order of the plurality of RIS groups. Accordingly, the processor (130) can set the linear increase rate so that the central directional angles of the beams for at least one RIS group are evenly distributed.

The second method is that the processor (130) may configure phase variation values of RIS elements within an RIS group to increase in a quadratic manner. The processor (130) may set the incremental phase variation values to increase quadratically based on the order of a plurality of RIS groups. As discussed earlier, the linear increase in phase variation values may only adjust the central direction of the beams corresponding to each of the plurality of RIS groups. However, when the phase variation values of the RIS elements within an RIS group are configured to increase quadratically, it is possible to adjust not only the central direction of the beams corresponding to each RIS group but also the beam width (thickness). Here, the processor (130) may configure the beam width to be identical across all RIS groups, with the value set to the total directional range divided by the number of groups (i.e., the number of beams). Furthermore, the processor may set (or design) the beam center directions of the RIS groups to be evenly distributed across the entire directional range.

The two previously discussed methods (linear increase and quadratic increase of phase variation values) correspond to a type of Heuristic approach.

The third method is that the processor (130) may control phase variation values of RIS elements within an RIS group to be set using a gradient-based optimization algorithm.

However, in the beamforming method in RIS element grouping according to the present invention, the methods for configuring phase variation value patterns to set reflection coefficient values of RIS groups are not limited to the aforementioned methods. Various other methods that can modify the patterns of the phase variation values may also be included.

Meanwhile, the beam gain of a signal varies depending on the channel direction angle. In communication services, the worst-case performance, which is generally emphasized, is determined by the minimum beam gain corresponding to the channel direction angle. The present invention has the advantage of significantly improving worst-case performance by maximizing the minimum beam gain according to the channel direction angle. Referring to FIG. 4, ‘Constant’ represents the performance of the conventional method in which the phase variation values of all RIS elements within a group are set to be the same, as previously discussed. ‘Linear’ and ‘Quadratic’ represent graphs showing the performance of methods where the phase variation values increase ‘linearly’ and ‘quadratically’, respectively, within the group. Finally, ‘Iterative’ represents a graph showing the performance of a method that uses phase variation value patterns acquired through a systematic iterative optimization algorithm.

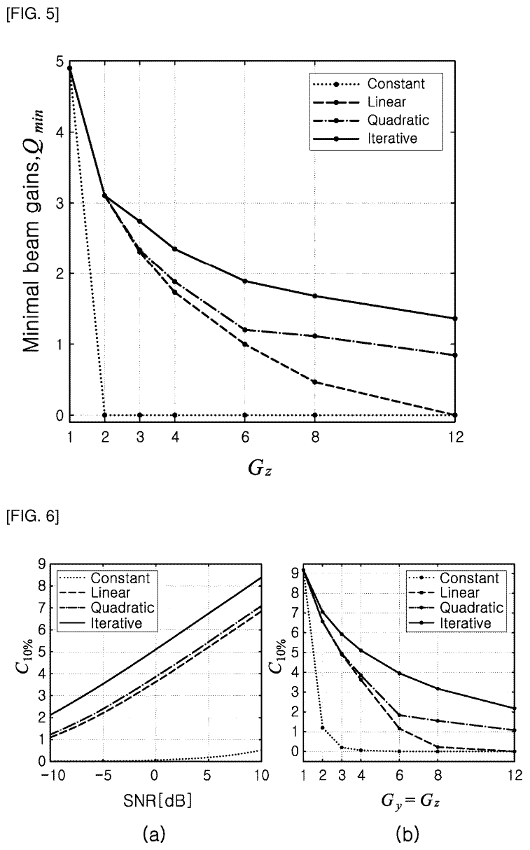

FIG. 5 is a graph comparing the minimum beam gain for each method based on the variation in the number of RIS elements (G_{z}) within each group. The horizontal axis represents G_{z}, while the vertical axis represents the minimum beam gain.

In FIG. 6, it is assumed that RIS elements are arranged in a planar structure of 24 rows and 24 columns. In (a) of FIG. 6, it is assumed that each group consists of 4 rows and 4 columns of RIS elements. The vertical axis represents the 10% outage capacity. The 10% outage capacity is defined as C_{10%} that satisfies Pᵣ[C≤C_{10%]=}0.1. Here, C refers to the channel capacity. The horizontal axis of (a) of FIG. 6 represents the signal-to-noise ratio (SNR).

(b) of FIG. 6 compares the 10% outage capacity based on the group size when SNR=0 dB. Here, G_{y} represents the number of rows in an RIS element array that forms each group, and Gz represents the number of columns. In all performance comparison graphs, it is shown that the beamforming method according to the present invention, which uses different phase variation patterns for each group, improves performance compared to the conventional method where all RIS elements within a group use the same phase variation value.

As discussed above, the present invention provides a beamforming method and device in RIS element grouping that can control the phase variation values of RIS elements differently to design the reflection coefficients differently for RIS elements within the same group. Accordingly, the present invention can address the problem of reduced beam gain in specific channel directions by setting different phase variation values for RIS elements within the same group.

Meanwhile, the beamforming method and device in RIS element grouping according to the present invention can be designed to evenly distribute the beam center direction angles of the groups by setting different linear increase rates for the RIS elements in each RIS group.

Meanwhile, the present invention can adjust not only the beam's center direction but also the beam's width (thickness) by increasing the phase variation values of the RIS elements within the same group in a quadratic manner.

Furthermore, the present invention can significantly improve worst-case performance by maximizing a minimum beam gain corresponding to a channel direction angle.

### INDUSTRIAL APPLICABILITY

The present invention is applicable to wireless devices and the like that provide beamforming functionality.

1. A beamforming method performed by a wireless device comprising at least one of Reconfigurable Intelligent Surface (RIS) groups, the beamforming method comprising:
acquiring a channel estimation value; and
determining reflection coefficients for the RIS groups based on the channel estimation value;
wherein a reflection coefficient for one of the RIS groups is different from a reflection coefficient for another of the RIS groups.

2. The beamforming method of claim 1,
wherein each of the RIS groups includes one or more RIS elements, and
wherein a reflection coefficient of the RIS group is calculated differently based on phase variation values of the one or more RIS elements.

3. The beamforming method of claim 2,
wherein the phase variation values are set differently for each of the one or more RIS elements included in an identical RIS group.

4. The beamforming method of claim 2,
wherein the RIS groups include a first RIS group and a second RIS group,
wherein phase variation value patterns of RIS elements included in the first RIS group and phase variation value patterns of RIS elements included in the second RIS group are set to be different from each other, and
wherein the phase variation value patterns are configured to maximize a minimum value of a signal beam gain according to a channel direction angle as much as possible.

5. The beamforming method of claim 2,
wherein the phase variation values are determined based on an order of a plurality of RIS groups, and
wherein, among the phase variation values, phase variation values for the second RIS group are greater than phase variation values for the first RIS group.

6. The beamforming method of claim 5,
wherein an increase rate of the phase variation value, increasing based on the order of the plurality of RIS groups, is set differently for each of the RIS groups.

7. The beamforming method of claim 5,
wherein the phase variation values, increasing based on the order of the plurality of RIS groups, increase in a quadratic manner.

8. The beamforming method of claim 5,
wherein the phase variation values are derived through an iterative optimization algorithm.

9. A beamforming device performed by a wireless device including at least one of Reconfigurable Intelligent Surface (RIS) groups, the beamforming device comprising:
one or more transceivers including the RIS groups;
one or more processors configured to control the one or more transceivers; and
one or more memories connected to the one or more processors and storing instructions which, when executed by the one or more processors, cause the processors to perform operations;
wherein the operations comprise:
acquiring a channel estimation value; and
determining reflection coefficients for the RIS groups based on the channel estimation value;
wherein a reflection coefficient for one of the RIS groups is different from a reflection coefficient for another of the RIS groups.

10. The beamforming device of claim 9,
wherein each of the RIS groups comprises one or more RIS elements, and
wherein reflection coefficients for the RIS groups are calculated differently based on phase variation values of the one or more RIS elements.
